(19) United States
(12) Patent Application Publication
(10) Pub. No.: US 2018/0130586 A1
(43) Pub. Date: May 10, 2018

(54) DEVICES AND SYSTEMS FOR DEFLECTING A LASER BEAM

(71) Applicant: Trumpf Laser Marking Systems AG, Gruesch (CH)

(72) Inventor: Fabio Jutzi, Chur (CH)

(21) Appl. No.: 15/862,766

(22) Filed: Jan. 5, 2018

Related U.S. Application Data
(63) Continuation of application No. PCT/EP2016/065255, filed on Jun. 30, 2016.

(30) Foreign Application Priority Data
Jul. 6, 2015 (EP) 15175387.8

(51) Int. Cl. H01F 7/02; G02B 26/08; G02B 7/182

(52) U.S. Cl. CPC H01F 7/0278; G02B 7/1821; G02B 26/085

(57) ABSTRACT

This disclosure relates to devices and systems for deflecting a laser beam. The devices include a mirror, a frame pivotally connected to the mirror and having a magnet axis, and at least one coil, which has a winding axis. The coil is connected to the frame and the permanent magnet is arranged in the magnetic field of the coil. The magnet axis and the winding axis of the coil do not extend in parallel when viewed in the direction perpendicular to a pivot axis of the mirror and the winding axis. The height of the cross section of the permanent magnet is less than or equal to twice the height of the coil cross section and the cross sections of permanent magnet and coil at least partially overlap. The permanent magnet is offset from a central position in the direction toward the mirror.

### CROSS REFERENCE TO RELATED APPLICATIONS

This application is a continuation of and claims priority under 35 U.S.C. § 120 from PCT Application No. PCT/EP2016/065255 filed on Jun. 30, 2016, which claims priority from European Application No. EP 15 175 387.8, filed on Jul. 6, 2015. The entire contents of each of these priority applications are incorporated herein by reference.

### TECHNICAL FIELD

The invention relates to devices and systems for deflecting laser beams.

### BACKGROUND

DE 27 18 532 A1 discloses a device for deflecting a laser beam. In the device disclosed in DE 27 18 532 A1, a permanent magnet, viewed in a direction perpendicular to a pivot axis of a mirror and to a winding axis, is arranged centrally in relation to a coil, and a height of a cross section of the permanent magnet is approximately one-third the height of the coil cross section.

Furthermore, a device for deflecting a laser beam based on MEMS technology comprising electromagnetic actuators is disclosed, for example, from Ataman et al., J. Micromech. Microeng., 23 (2013) 025002 (13 pages) or from T. Iseki et al., OPTICAL REVIEW, Vol. 13, No. 4 (2006) 189-194.

Devices for deflecting a laser beam, in particular in arrangements for laser material processing, generally offer a high dynamic response with respect to angular velocity and angular acceleration and also a high accuracy with respect to angle setting and reproducibility. At the same time, the laser beams used are continuously becoming higher power and the installation spaces are gradually becoming smaller. Scanners based on MEMS (micro-electromechanical systems) and in particular devices that are based on electromagnetic actuators offer a technology of interest here.

Ataman et al. discloses a MEMS scanner, in which the coils of the actuator are designed as flat coils.

Iseki et al. discloses a gimbal-mounted deflection mirror, the electromagnetic actuator of which is based on the interaction of a permanent magnet with coil arrangements.

However, in the deflection devices disclosed by the aforementioned references, the achievable angular accelerations and angular velocities are not sufficiently high to achieve cost-effective processing speeds in applications for laser processing. This is true in particular if the processing requires not only a constant angular velocity of the mirror, but rather a rapid change between various angular velocities. The setting and repetition accuracy of the laser beam deflection decisively determines the quality of the processing result and therefore the process reliability of the processing process. The known concepts also do not meet the requirements for industrial use here.

### SUMMARY

The present disclosure relates to devices and systems for deflecting laser beams configured such that the dynamic response is increased with respect to angular velocity and angular acceleration and also the accuracy is improved with respect to angle setting and reproducibility.

In one aspect, the devices include a mirror, a frame, in which the mirror is pivotably mounted, a permanent magnet rigidly connected to the mirror and the north and south poles of which define a magnet axis, and at least one coil for exerting a magnetic deflection force on the permanent magnet. The permanent magnet is arranged offset in the direction toward the mirror in relation to a central position with respect to the coil. The at least one coil has a winding axis around which the coil turns are wound. The at least one coil is rigidly connected to the frame and the permanent magnet is arranged in the magnetic field of the coil. The magnet axis and the winding axis of the coil do not extend in parallel, viewed in the direction perpendicular to the pivot axis of the mirror and to the winding axis. The height of the cross section of the permanent magnet is less than or equal to twice the height of the coil cross section and the cross sections of permanent magnet and coil at least partially overlap.

As current flows through the coil mentioned at the outset, it generates a magnetic field \vec{B}, which has a region of high field strength close to the end face, in which the field lines are oriented parallel to the coil axis. At a greater distance from the coil end face, the field lines change the direction thereof and the field strength sinks. The following equations apply for the torque \vec{T}, which engages on a magnet having the magnetic moment \vec{m} in a homogeneous magnetic field:

\vec{T}=\vec{m}×\vec{B} and |\vec{T}|=|\vec{m}×\vec{B}|=|\vec{m}∥\vec{B}| sin θ,

wherein θ denotes the angle between the two vectors. The permanent magnet may be arranged in the region of high field strength, so that the cross sections of the coil and the permanent magnet at least partially overlap. It is to be ensured in this case that the magnet axis and the winding axis of the coil do not extend parallel to one another. Accordingly, \vec{m} and \vec{B} are also not parallel and sin θ≠0.

Permanent magnets consist, for example, of SmCo or NdFeB. Such materials have a high density. To keep the moment of inertia of the moving parts of the device low, the volume of the permanent magnet is advantageously concentrated on the region in which the magnetic moment of the permanent magnet can interact with a significant external magnetic field. This is achieved in that the height of the cross section of the permanent magnet is limited to twice the height of the coil cross section, and the permanent magnet is arranged in the magnetic field of the coil so that the cross sections of the coil and the permanent magnet at least partially overlap. A high force and/or a high torque of the actuation can contribute to a high dynamic response of the deflection device, according to implementations of the invention.

According to certain implementations of the invention, the permanent magnet is arranged offset in relation to a central position with respect to the coil. The torque engaging on the permanent magnet is thus reduced, since a lower external magnetic field, because it is inhomogeneous, acts on the permanent magnet in its position offset in the direction of the mirror. However, a force component engaging in addition to the torque on the permanent magnet arises due to the magnetic field, which is now inhomogeneous. According to particular implementations of the invention, the permanent magnet is arranged offset in the direction toward the mirror. The moment of inertia is thus reduced in relation to off-center positioning in the opposite direction. In total, an increase of the torque acting at the rotational axis on the mirror results, so that higher angular velocities and angular accelerations are achievable.

In certain implementations, the magnet axis and the winding axis intersect and enclose an angle not equal to zero with one another. In this case, the dynamic response plays out in the plane spanned by the magnetic moment and the coil axis, and the deflection device according to the invention therefore has positive properties for the actuation. The angle not equal to zero may be 90°. In implementations where the angle is 90°, the absolute value of the torque that acts on the magnet when current flows through the coil is maximal.

The height of the cross section of the permanent magnet is between 0.3 times and 0.6 times the height of the coil cross section, in particular implementations. This configuration enables the greatest possible overlap of the cross sections of the permanent magnet and the at least one coil.

In certain implementations, the height of the cross section of the permanent magnet is less than the height of the coil cross section. This enables an optimized positioning of the permanent magnet in the region of high field strength, without the overlap of the cross sections of the coil and the permanent magnet decreasing.

The overlap of the cross sections of permanent magnet and coil influences the dimension of the torque that acts on the permanent magnet in the magnetic field of the coil. The height overlap of the cross sections of the coil and the permanent magnet is therefore greater than or equal to 50% of the lesser of the two heights, in certain implementations. The height overlap of the cross sections of the coil and the permanent magnet is equal to 100% of the lesser of the two heights, in particular implementations.

It is apparent from the preceding statements that a suitable positioning of the permanent magnet in the magnetic field of the coil plays an important role for the dimension of the torque that can be generated and therefore for the achievable angular acceleration and angular velocity in the deflection of a laser beam. It is also apparent that the effects on the inertial mass of the moving parts of the device have to be taken into consideration in the selection of the dimensions of the permanent magnet. In certain implementations, a spacer made of nonferromagnetic material, via the length of which the spacing between the center point of the permanent magnet and the winding axis of the at least one coil can be defined, is arranged between the permanent magnet and the connecting element, by which the mirror is pivotably mounted in the frame.

The device comprises multiple coils each having a winding axis, in particular implementations. The winding axes of the coils can be non-collinear, for example, so that forces can act from various directions on the permanent magnet and the mirror is pivotable in more than one direction. In certain implementations, at least two coils having the same winding direction are provided on a winding axis and the permanent magnet is arranged between the at least two coils. In this case, both attractive and also repulsive forces can contribute to the torque. In particular embodiments, the device comprises two winding axes having coils, which are perpendicular in relation to one another and to the magnet axis. Such embodiments are particularly advantageous with respect to a simple actuation during a deflection of the mirror about various pivot axes.

The force that a current-conducting coil can exert on a permanent magnet in its magnetic field increases with the inductance L of the coil. The inductance of a coil may be increased by introducing a core of a ferromagnetic material into the coil. If a voltage is applied to a coil, the current in the coil first results gradually because of an opposing induction voltage, wherein the time constant increases with the inductance of the coil. As a result, a higher inductance of the at least one coil results in a more sluggish reaction of the device to the deflection of a laser beam upon a change of the specification signal and therefore has a negative effect on the achievable deflection velocity and angular acceleration. An increase of the inductance via the introduction of a ferromagnetic coil core furthermore results in additional losses due to repeated re-magnetization of the coil core in the temporally changeable field of the moving permanent magnet. Furthermore, ferromagnetic coil cores display a nonlinear response to a change of the current strength in the coil up to hysteresis. The accuracy of the angle setting and the repetition accuracy of the angle setting in the device for beam deflection is thus reduced. In particular embodiments of the device, by way of the dimensioning and arrangement of permanent magnet and the at least one coil, the torques are sufficiently large and the moments of inertia are sufficiently small that a coil core made of nonferromagnetic material is provided for the at least one coil, and the inductance of the at least one coil is sufficiently small that sufficient accuracies are achieved by an actuation using a simple, for example, linear, regulation.

Unavoidable power losses during the operation of the deflection device arise, for example, because of the ohmic resistance of the at least one coil and, without further measures, result in an at least local temperature increase. Such a temperature increase is undesirable in the sense of accurate and reproducible deflection of the mirror. A discharge of occurring power loss to the frame, for example, is therefore advantageous. The at least one coil may be wound around a coil core, which can consist of a copper alloy, an aluminum alloy, aluminum oxide, or aluminum nitride, in accordance with certain implementations. These materials have very good heat conduction properties. Because the magnet axis and winding axis are not parallel, the occurrence of eddy currents in electrically conductive coil cores is substantially reduced, since the magnetic field strength acting on the coil core is substantially lower than in the case of parallel magnetic field and winding axes. Losses in electrically conductive coil cores are thus reduced and the actuation capability of the deflection device is improved, since the induction of eddy currents acts like additional damping. Coil cores made of aluminum oxide and aluminum nitride are advantageous in particular, since no losses due to eddy currents are induced therein.

To counteract a deformation of the mirror in the event of a temperature increase, the mirror can be provided on both sides with a coating, e.g., of equal thickness. The coating can be a metallic-dielectric hybrid coating, in certain implementations.

The permanent magnet is spaced apart closer to the mirror than the coil in particular implementations and may overlap on 50% to 100% of its height with the cross section of the coil.

In another aspect, the present disclosure provides deflection device systems. The deflection device systems include a deflection device, a controller for actuating the deflection device, and a sensor for measuring the pivot angle of the mirror and for generating an input signal for the controller. The deflection device includes a mirror, a frame, in which the mirror is pivotably mounted, a permanent magnet that is rigidly connected to the mirror and the north and south poles of which define a magnet axis, and at least one coil for exerting a magnetic deflection force on the permanent magnet. The permanent magnet is arranged offset in the direction toward the mirror in relation to a central position with respect to the coil. The at least one coil has a winding axis around which the coil turns are wound. The at least one coil is rigidly connected to the frame and the permanent magnet is arranged in the magnetic field of the coil, wherein the magnet axis and the winding axis of the coil do not extend in parallel, wherein, viewed in the direction perpendicular to the pivot axis of the mirror and to the winding axis, the height of the cross section of the permanent magnet is less than or equal to twice the height of the coil cross section and the cross sections of the permanent magnet and the coil at least partially overlap. The controller sets the current that flows through the at least one coil of the device via an output signal. The output signal is determined using a setpoint value and a transfer function of the system.

In certain embodiments, the device displays a characteristic curve that is linear in a good approximation, i.e., the pivot angle of the mirror and the value of the specification signal are linearly dependent on one another in a good approximation. The requirements of modern laser processing can then be fulfilled by the arrangement according to embodiments of the invention using a simple regulation, which is based on the principles of linear system theory.

Further advantages and advantageous embodiments of the subject matter of the invention result from the description, the claims, and the drawings. The above-mentioned features and the features to be set forth hereafter can also each be used per se or together in arbitrary combinations. The embodiments shown and described are not to be understood as an exhaustive list, but rather have exemplary character for the description of the invention.

Exemplary embodiments of the invention are schematically illustrated in the drawing and will be explained in greater detail hereafter with reference to the figures of the drawing.

### DESCRIPTION OF DRAWINGS

FIG. 1 shows a longitudinal sectional illustration of a first device according to embodiments of the invention for the one-dimensional deflection of a laser beam.

FIG. 2 shows a bottom view of a second device according to embodiments of the invention for the two-dimensional deflection of a laser beam.

FIGS. 3 and 4 show a third and a fourth device according to embodiments of the invention for the two-dimensional deflection of a laser beam, each in a longitudinal sectional illustration similar to FIG. 1.

FIGS. 5A-5I show cross sections of the permanent magnet and the at least one coil for various embodiments of the invention.

FIG. 6 shows a deflection device system comprising a device according to embodiments of the invention.

### DETAILED DESCRIPTION

In the following description of the drawings, identical reference signs are used for identical or functionally identical components.

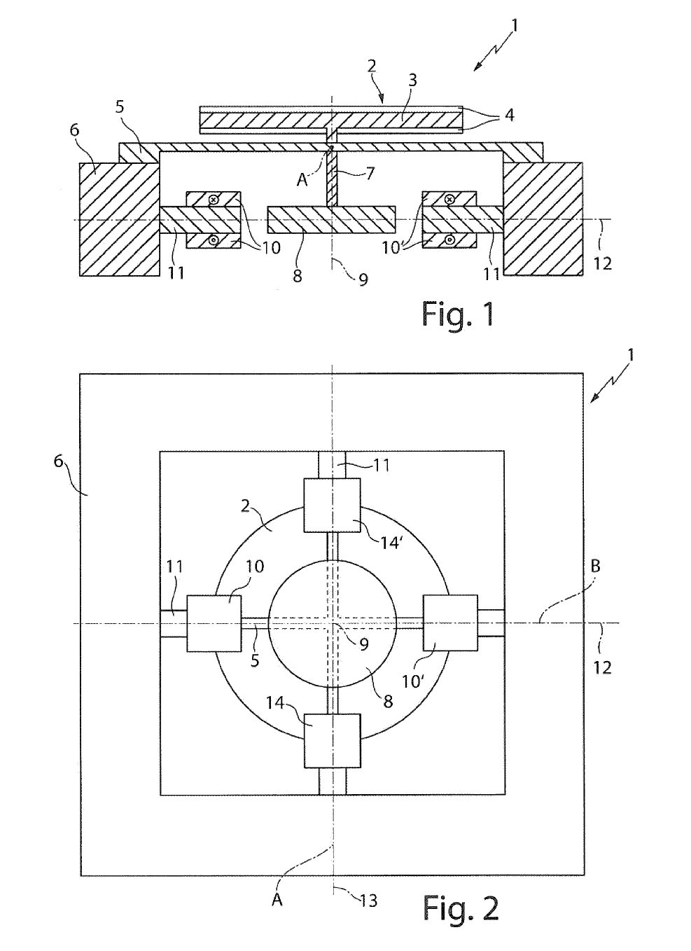

FIG. 1 shows a device 1 according to implementations of the invention for the one-dimensional deflection of a laser beam by means of a mirror 2, for which a reflective coating 4 of equal thickness is applied on both sides to a mirror substrate 3, for example, made of a semiconductor material. The reflective coating 4 can be, for example, a metallic layer, a dielectric layer, or a metallic-dielectric hybrid layer, wherein this also includes layer stacks or layer systems. The mirror 2 is fastened on the upper side of a connecting element 5, which can be formed as a solid-state joint, as shown, and is thus mounted so it is pivotable in a frame 6 about an axis A.

A permanent magnet 8 is connected via a spacer 7, for example, made of a nonferromagnetic material, to the lower side of the connecting element 5 and is thus also rigidly connected to the mirror 2 arranged on the connecting element 5. The permanent magnet 8 is designed as a cylinder having a north pole and a south pole, wherein these magnetic poles are arranged on the cylinder upper side and lower side and define a magnet axis 9, which is coincident with the cylinder axis and/or the axis of symmetry of the permanent magnet 8. The permanent magnet can also have other geometries.

The permanent magnet 8 is arranged between two coils 10, 10′, which are each rigidly connected to the frame 6 via a coil core 11 (for example, made of a nonferromagnetic material) and have a common winding axis 12, around which the coil turns are wound. They have the same winding direction with respect to a current flow in the coils 10, 10′. The magnet axis 9 and the winding axis 12 do not extend in parallel, but rather intersect at an angle not equal to zero, namely at an angle of 90° in FIG. 1, solely by way of example. The length of the spacer 7 defines the spacing between the center point of the permanent magnet 8 and the winding axis 12. If current flows in the coils 10, 10′, the permanent magnet 8 is arranged in the magnetic field generated by the coils and is thus deflected about the axis A against the restoring force of the connecting element 5. The mirror 2, which is rigidly connected to the permanent magnet 8, is thus one-dimensionally deflected.

Heat loss, for example, because of the ohmic resistance of the coils 10, 10′, is dissipated via the contact of the coil cores 11 to the frame 6. Coil cores 11 made of material having a high thermal conductivity, for example, aluminum alloys, aluminum oxide, or aluminum nitride, are particularly suitable for this purpose.

FIG. 2 shows a device 1 according to implementations of the invention for the two-dimensional deflection of a laser beam by means of a mirror 2, which is fastened on the upper side of a cross-shaped connecting element 5, which can be designed as a solid-state joint as shown and is mounted so it is pivotable about two axes A, B perpendicular to one another in the frame 6. Instead of the cross-shaped connecting element shown, other embodiments can also be used, for example, a diaphragm spring configured as a solid-state joint having spiral curved spokes.

The permanent magnet 8 is arranged between two coil pairs 10, 10′ and 14, 14′, which are each rigidly connected to the frame 6 via a coil core 11 (for example, made of a nonferromagnetic material). Each coil pair has a common winding axis 12, 13, about which the coil turns are wound. The coils of each coil pair have the same winding direction with respect to a current flow in a coil pair. The two winding axes 12, 13 are not collinear, but rather are each perpendicular to one another and to the magnet axis 9 of the permanent magnet 8. If current flows in the coils 10, 10′ and 14, 14′, the permanent magnet 8 is arranged in each case in the magnetic field generated by the coils and is thus deflected about the axes A, B against the restoring force of the connecting element 5. The deflection of the mirror rigidly connected to the permanent magnet 8 results accordingly from the superposition of the deflection about the axes A, B.

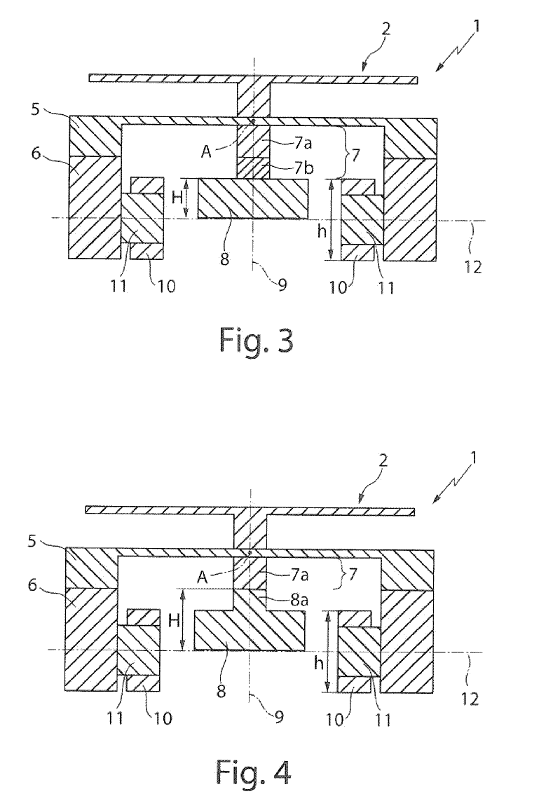

In the device 1 shown in FIG. 3 for the two-dimensional deflection of a laser beam, the spacer 7 is formed both by a post 7a of the nonmagnetic mirror 2 or its mirror holder and also by a nonferromagnetic post part 7b. The permanent magnet 8 is arranged offset in relation to a central position with respect to the coils 10, 10′, 14, 14′ in the direction toward the mirror 2 and overlaps 50% to 100%, 100% as shown here, of its height H with the cross section of the coils 10, 10′, 14, 14′. In the exemplary embodiment shown, the height H of the permanent magnet 8 is approximately 0.9 to 1 mm and the height h of the coils 10, 10′, 14, 14′ is approximately 2.3 mm, wherein the height H of the cross section of the permanent magnet 8 is approximately 0.39 times the height h of the coil cross section.

In the device 1 shown in FIG. 4 for the two-dimensional deflection of a laser beam, the spacer 7 is formed by a pillar 7a of the nonmagnetic mirror holder. In contrast to FIG. 3, the permanent magnet 8 has a stepped cross section having an upper attachment pillar 8a, which is fastened on the pillar 7a of the spacer 7. The permanent magnet 8 is arranged offset in relation to a central position with respect to the coils 10, 10′, 14, 14′ in the direction of the mirror 2 and overlaps 50% to 100%, approximately 80% as shown here, of its height H with the cross section of the coils 10, 10′, 14, 14′. In the exemplary embodiment shown, the height H of the permanent magnet 8 is approximately 1.1 mm and the height h of the coils 10, 10′, 14, 14′ is approximately 2.3 mm, wherein the permanent magnet 8 overlaps at 0.9 mm with the cross section of the coils 10, 10′, 14, 14′ and the height H of the cross section of the permanent magnet 8 is approximately 0.48 times the height h of the coil cross section. The permanent magnet 8 is thus spaced apart closer to the mirror 2 than the coils 10, 10′, 14, 14′.

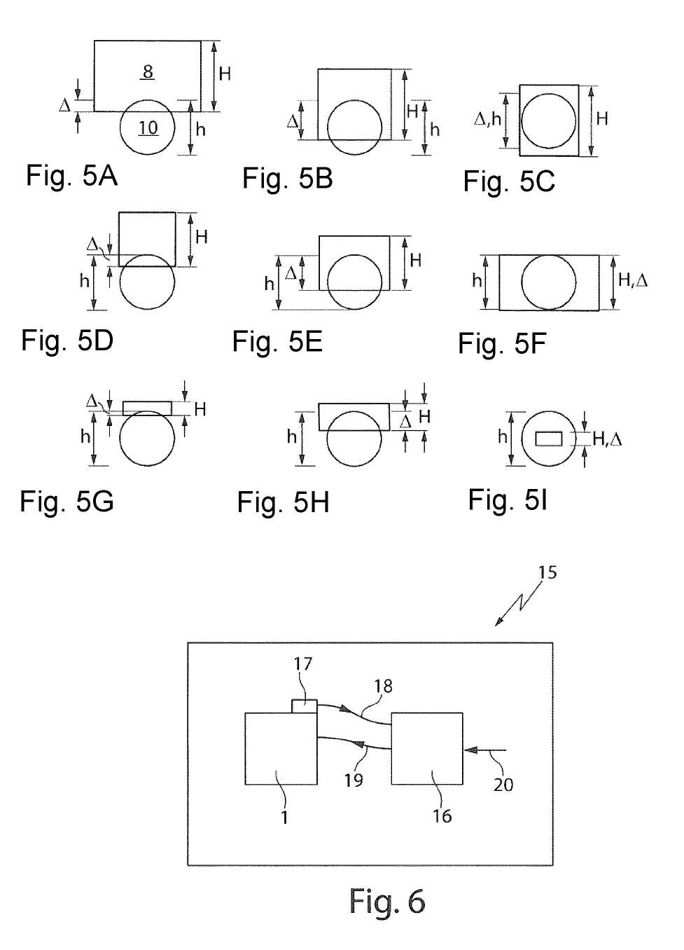

FIGS. 5A-5I show various cross-sections of the permanent magnet 8 and the coil 10 for various embodiments according to the invention, wherein the cross section is to be understood as a section perpendicular to the associated winding axis 12. The height of the cross section is understood as the maximum extension of the cross section in the direction perpendicular to the pivot axis A of the mirror 2 and to the winding axis 12. These definitions each relate to the idle position of the permanent magnet 8, i.e., to the state when no current flows through the coil 10.

FIG. 5A shows a particular implementation of the invention, in which the height H of the cross section of the permanent magnet 8 is less than twice the height h of the coil cross section and the cross sections of permanent magnet 8 and coil 10 partially overlap.

FIG. 5B shows an implementation in which the height H of the cross section of the permanent magnet 8 is less than twice the height h of the coil cross section and the height overlap Δ of the cross sections of permanent magnet 8 and coil 10 is greater than or equal to 50% of the height h of the cross section of the coil 10.

FIG. 5C shows an implementation in which the height H of the cross section of the permanent magnet 8 is less than twice the height h of the coil cross section and the height overlap Δ of the cross sections of permanent magnet 8 and coil 10 is equal to the height h of the cross section of the coil 10.

FIG. 5D shows an implementation in which the height H of the cross section of the permanent magnet 8 is between 0.9 times and 1.1 times the height h of the coil cross section, in particular is equal to the height h of the coil cross section, and the cross sections of permanent magnet 8 and coil 10 partially overlap.

FIG. 5E shows an implementation in which the height H of the cross section of the permanent magnet 8 is between 0.9 times and 1.1 times the height h of the coil cross section, in particular is equal to the height of the coil cross section, and the height overlap Δ of the cross sections of permanent magnet 8 and coil 10 is greater than or equal to 50% of the lesser of the two heights h, H.

FIG. 5F shows an implementation in which the height H of the cross section of the permanent magnet 8 is between 0.9 times and 1.1 times the height h of the coil cross section, in particular is equal to the height h of the coil cross section, and the height overlap Δ of the cross sections of permanent magnet 8 and coil 10 is equal to 100% of the lesser of the two heights h, H.

FIG. 5G shows an implementation in which the height H of the cross section of the permanent magnet 8 is less than the height h of the coil cross section and the cross sections of permanent magnet 8 and coil 10 partially overlap.

FIG. 5H shows an implementation in which the height H of the cross section of the permanent magnet 8 is less than the height h of the coil cross section and the height overlap Δ of the cross sections of permanent magnet 8 and coil 10 is greater than or equal to 50% of the height H of the cross section of the permanent magnet 8.

FIG. 5I shows an implementation in which the height H of the cross section of the permanent magnet 8 is less than the height h of the coil cross section and the height overlap Δ of the cross sections of permanent magnet 8 and coil 10 is equal to the height H of the permanent magnet 8. In contrast to FIG. 5h, the cross section of the permanent magnet 8 lies completely inside the cross section of the coil 10.

FIG. 6 shows an arrangement 15 comprising the deflection device 1, a controller 16 for actuating the deflection device 1, and a sensor 17 for measuring the pivot angle of the mirror 2. The sensor 17 generates an input signal 18 for the controller 16, wherein the controller 16 sets the current that flows through the at least one coil of the deflection device 1 via an output signal 19. In this case, the output signal 19 is determined using a setpoint value 20 and a transfer function of the system, wherein the transfer function reflects a relationship between input and output signal of the open control loop.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A device for deflecting a laser beam, comprising
a mirror;
a frame, to which the mirror is connected so it is pivotable;
a permanent magnet rigidly connected to the mirror and having a north pole and a south pole that define a magnet axis; and
at least one coil for exerting a magnetic deflection force on the permanent magnet,
wherein the at least one coil has a winding axis about which coil turns are wound,
wherein the at least one coil is rigidly connected to the frame and the permanent magnet is positioned in the magnetic field of the at least one coil,
wherein the magnet axis and the winding axis of the at least one coil do not extend in parallel, wherein, viewed in the direction perpendicular to the pivot axis of the mirror and the winding axis, the height of the cross section of the permanent magnet is less than or equal to twice the height of a cross section of the at least one coil, wherein a cross section of the permanent magnet and the cross section of the at least one coil at least partially overlap, and
wherein the permanent magnet is positioned offset from a central position with respect to the at least one coil in a direction toward the mirror.

2. The device of claim 1, wherein the height of the cross section of the permanent magnet is between 0.3 times and 0.6 times the height of the cross section of the at least one coil.

3. The device of claim 1, wherein the height of the cross section of the permanent magnet is less than the height of the cross section of the at least one coil.

4. The device of claim 1, wherein a height overlap (Δ) of the cross sections of the permanent magnet and the at least one coil is greater than or equal to 50% of the lesser of the height of the cross section of the at least one coil and the cross section of the permanent magnet.

5. The device of claim 4, wherein the height overlap (Δ) is equal to 100% of the lesser of the height of the cross section of the at least one coil and the cross section of the permanent magnet.

6. The device of claim 1, wherein the mirror is pivotably mounted on the frame via a connecting element and wherein a spacer is arranged between the permanent magnet and the connecting element, the length of which connecting element defines a space between a center point of the permanent magnet and the winding axis of the at least one coil.

7. The device of claim 1, wherein the at least one coil has a coil core made of a nonferromagnetic material.

8. The device of claim 7, wherein the coil core of the at least one coil consists of a copper alloy, an aluminum alloy, aluminum oxide, or aluminum nitride.

9. The device of claim 1, wherein the mirror is provided on both sides with a metallic-dielectric hybrid coating.

10. The device of claim 9, wherein the dielectric hybrid coating on both sides are of equal thickness.

11. The device of claim 1, wherein the permanent magnet is spaced apart closer to the mirror than the at least one coil.

12. The device of claim 1, wherein the permanent magnet overlaps on 50% to 100% of its height with the cross section of the at least one coil.

13. A deflection device system comprising:
a deflection device comprising:
a mirror,
a frame, to which the mirror is connected so it is pivotable,
a permanent magnet rigidly connected to the mirror and having a north pole and a south pole that define a magnet axis, and
at least one coil for exerting a magnetic deflection force on the permanent magnet, wherein the at least one coil has a winding axis about which coil turns are wound,
wherein the at least one coil is rigidly connected to the frame and the permanent magnet is positioned in the magnetic field of the at least one coil, wherein the magnet axis and the winding axis of the at least one coil do not extend in parallel, wherein, viewed in the direction perpendicular to the pivot axis of the mirror and the winding axis, the height of the cross section of the permanent magnet is less than or equal to twice the height of a cross section of the at least one coil, wherein a cross section of the permanent magnet and the cross section of the at least one coil at least partially overlap, and
wherein the permanent magnet is positioned offset from a central position with respect to the at least one coil in a direction toward the mirror;
a controller for actuating the deflection device; and
a sensor for measuring the pivot angle of the mirror and for generating an input signal for the controller,
wherein the controller is configured to set the current that flows through the at least one coil of the deflection device via an output signal and wherein the output signal is determined using a setpoint value and a transfer function of the deflection device system.
